(19) United States
(12) Patent Application Publication
(10) Pub. No.: US 2006/0188099 A1
(43) Pub. Date: Aug. 24, 2006

(54) Key management system and method for the same

(75) Inventors: Atsushi Kondo, Kanagawa (JP); Ichiro Kimura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/347,226

(22) Filed: Feb. 6, 2006

(30) Foreign Application Priority Data
Feb. 21, 2005 (JP) 2005-044569

(51) Int. Cl. H04L 9/00

(52) U.S. Cl. 380/277

(57) ABSTRACT

An inexpensive and secure key management system provides a digital content copy protection system and a method for the same. The key management system is constituted by a master data memory configured to be stored with a device key, a secret data management block configured to convert the device key to a plain text key, a write-in and encryption process block including an encrypting function block for encrypting the plain text key, a nonvolatile memory configured in a first chip and stored with an encryption key encrypted by the write-in and encryption process block, and a signal processing LSI configured in a second chip and including a decrypting function block for decrypting the encryption key.

### CROSS REFERENCE TO RELATED APPLICATIONS AND INCORPORATION BY REFERENCE

This application is based upon and claims the benefit of priority from prior Japanese Patent Application P2005-44569 filed on Feb. 21, 2005; the entire contents of which are incorporated by reference herein.

### BACKGROUND OF THE INVENTION

1. FIELD OF THE INVENTION

The present invention relates to a key management system and a method for the same. More specifically, it relates to a device key management system and a method for the same, which are used by LSIs for encrypting content data.

2. DESCRIPTION OF THE RELATED ART

Content protection technologies for protecting productions or contents, such as movies digitally recorded on a DVD, have standards for encryption and decryption of such contents and acquisition of keys therefor. When developing and fabricating products under license for such technologies, robust security to prevent reveal of secret information included in a product itself is required. In addition, such secret information should be securely managed so as not to be revealed, even during the fabrication process for the product.

A very effective method for ensuring information security of products is to embed protection mechanisms in LSI packages. However, secret information of decryption keys for encrypted contents is recorded on each LSI (product). Since this secret information is written while mounting each LSI, a secret management mechanism is required in the product fabrication stage.

Since device keys for digital content copy protection systems differ for each product, board/equipment manufacturers which implement signal processing LSIs including a digital content copy protection system encounter the following problems. LSI manufacturers also have similar problems. Namely, (i) since a device key is highly secret information, investment in an additional facility is required for introducing a device key encryption and an encrypted device key data write-in process so as to prevent disclosure of device key values, and (ii) secret information management for device keys is required in addition to production/fabrication management.

When fabricating signal processing LSIs including a nonvolatile memory, such as an EEPROM for storing device keys, there is a problem that it becomes difficult to fabricate LSIs including a nonvolatile memory, such as an EEPROM through ordinary processes as miniaturization of the LSI fabrication process progresses. Thus, an additional expensive optional process becomes essential. In addition, in the case of encapsulating two IC chips in an LSI, such as a multi-chip module without using a memory embedding process, there is a similar problem that a complex fabrication process for encapsulating two LSI chips is required, resulting in increased cost of the LSI.

A known information processing apparatus is constituted by an encryption/decryption LSI including a common LSI key shared with other devices and a ROM stored with device keys unique to respective devices. The apparatus reads out a device key from the ROM, generates a data key unique to a device based on the device key and an embedded LSI key, and encrypts/decrypts data using the generated data key by the encryption/decryption LSI to prevent data from being illegally copied, (e.g., see Domestic Re-publication of PCT International Publication No. WO01/030019 (P2001-531253)).

### SUMMARY OF THE INVENTION

An aspect of the present invention inheres in a key management system, which includes a master data memory configured to store a device key;

a secret data management block configured to convert the device key to a plain text key; a write-in and encryption process block configured to include an encryption function block and encrypt the plain text key; a nonvolatile memory configured in a first chip and stored with an encryption key encrypted by the write-in and encryption process block; and a signal processing LSI configured in a second chip and including a decrypting function block for decrypting the encryption key.

Another aspect of the present invention inheres in a key management system, which includes a master data memory configured to store a device key; a secret data management block configured to convert the device key to a plain text key; a write-in and encryption process block configured to include an encryption function block and encrypt the plain text key; a recording medium configured to store an encryption key encrypted by the write-in and encryption process block; and a signal processing LSI including a decrypting function block for decrypting the encryption key.

Another aspect of the present invention inheres in a key management method, which includes receiving a device key stored in a master data memory; converting the device key to a plain text key by a secret data management block;

encrypting the plain text key by a write-in and encryption process block including an encryption function block; recording an encryption key encrypted by the write-in and encryption process block in a nonvolatile memory configured in a first chip; and fabricating a signal processing LSI configured in a second chip and including a decrypting function block for decrypting the encryption key.

Another aspect of the present invention inheres in a key management method, which includes receiving a device key stored in a master data memory; converting the device key to a plain text key by a secret data management block;

encrypting the plain text key by a write-in and encryption process block including an encryption function block; storing, in a recording medium, an encryption key encrypted by the write-in and encryption process block; and fabricating a signal processing LSI including a decrypting function block for decrypting the encryption key.

### BRIEF DESCRIPTION OF THE DRAWINGS

FIG. 1 schematically shows a block diagram of a key management system according to a first embodiment of the present invention;

FIG. 2 schematically shows a block diagram of a key management system according to a second embodiment of the present invention;

FIG. 3 schematically shows a block diagram of a key management system according to a comparative example;

FIG. 4 schematically shows a block diagram of a key management system according to another comparative example; and

FIG. 5 schematically shows a block diagram of a key management system according to yet another comparative example.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

Referring to the drawings, embodiments of the present invention are described below. The embodiments shown below exemplify an apparatus and a method that are used to implement the technical ideas according to the present invention, and do not limit the technical ideas according to the present invention to those that appear below. These technical ideas, according to the present invention, may receive a variety of modifications that fall within the claims.

Note that those drawings are merely schematics and thus two-dimensional size of respective parts, sizes of horizontal and vertical axes of respective timing waveforms, and timing shapes of respective burst waveforms may be inconsistent with reality according to the present invention. Moreover, it is natural that there are parts differing in relationship and ratio of dimensions among the drawings.

A key management system, which includes a nonvolatile memory, such as an EEPROM storing device key data or encrypted device keys purchased from a licensor and a signal processing LSI for decrypting an encrypted device key and preventing copies of digital contents, and a method for the same are provided to board/equipment manufacturers.

### COMPARATIVE EXAMPLE

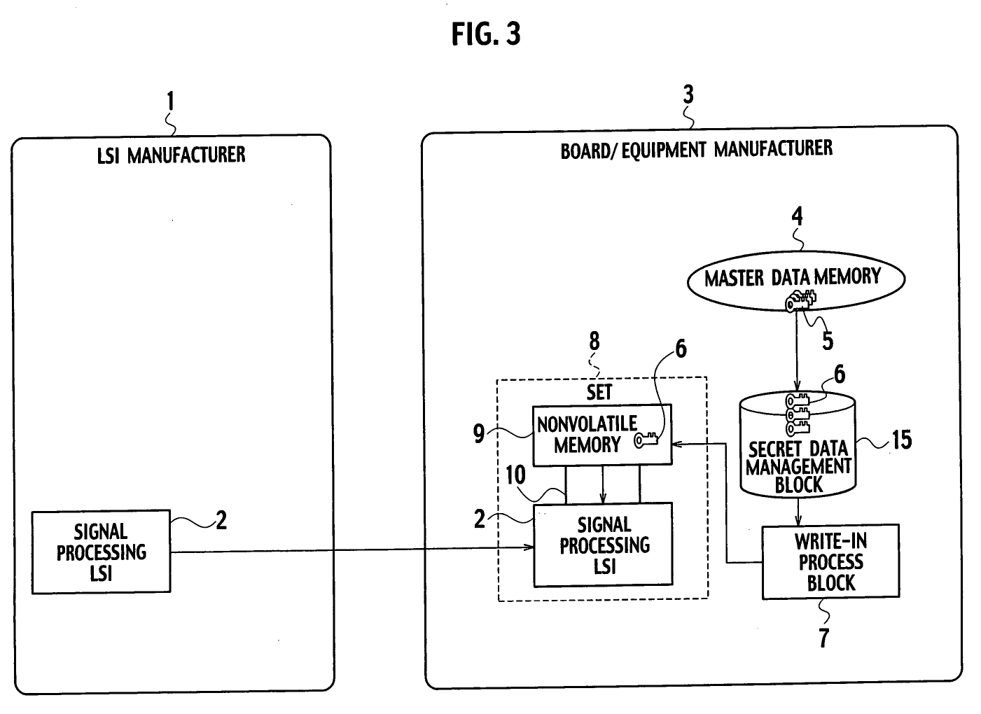

FIG. 3 shows a comparative example as a basis for embodiments of the present invention. An LSI manufacturer 1 manufactures a signal processing LSI 2 for encrypting content data, and provides it to a board/equipment manufacturer 3.

The board/equipment manufacturer 3 receives, from an encryption licensor, a master data memory 4 stored with, for example, one hundred thousand sets of device keys 5, and then converts the device keys 5 to plain text keys 6 (each being a single set of device key in plain text) via a secret data management block 15. The plain text keys 6 are subjected to a write-in process by a write-in process block 7, and written as a plain text key 6 in a nonvolatile memory 9 of a set 8. The plain text key 6 stored in the nonvolatile memory 9 is read out to the signal processing LSI 2 of the set 8. In this case, in order to keep this data communication secret, the two LSI terminals and a board substrate interconnect portion should be sealed with resin 10 so as to be shut off from external contact.

As described above, according to the comparative example of FIG. 3, data of the device keys 5 is handled in a plain text key 6 format as is the write-in process block 7 writing the plain text key 6 in the nonvolatile memory 9. This requires complete information management for highly confidential data. The interconnect portions on the set 8 extending from the nonvolatile memory 9, storing the plain text key 6, to the signal processing LSI 2 are only coated with the resin 10. Thus, the secrecy security level is low. In addition, cost of the resin is increased.

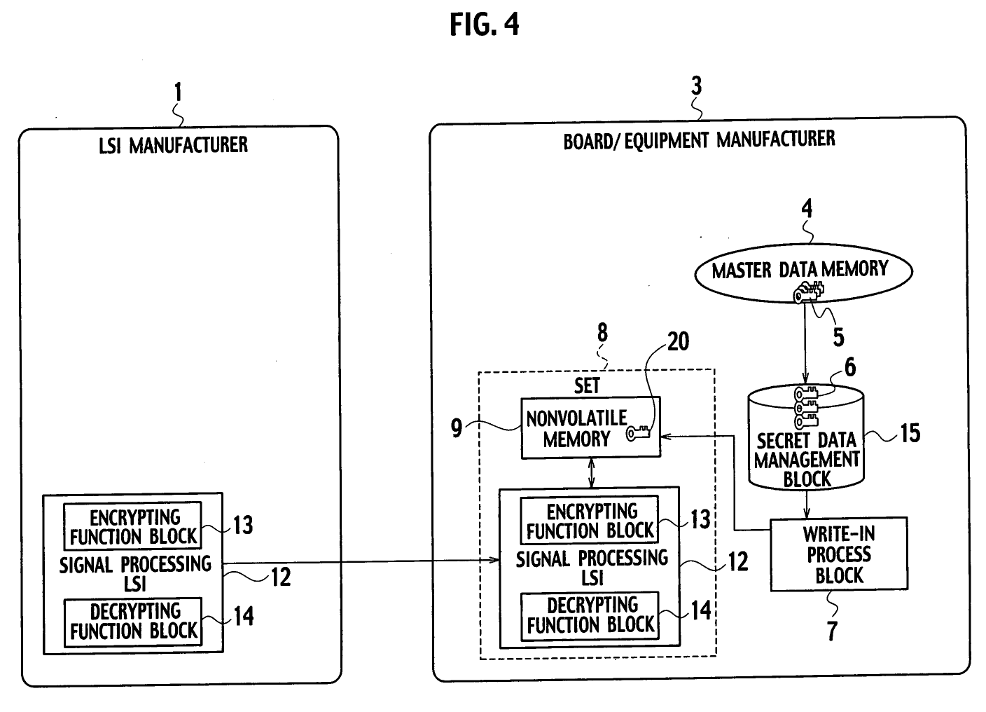

FIG. 4 shows another comparative example as a basis for the embodiments of the present invention. An LSI manufacturer 1 manufactures a signal processing LSI 12, which includes an encrypting function block 13 and a decrypting function block 14 and encrypts content data, and provides the LSI to a board/equipment manufacturer 3.

The board/equipment manufacturer 3 receives, from an encryption licensor, a master data memory 4 stored with, for example, one hundred thousand sets of device keys 5, and then converts the device keys 5 to plain text keys 6 via a secret data management block 15. Each of the plain text keys 6 is subjected to a write-in process by a write-in process block 7, and written in a nonvolatile memory 9 of a set 8.

The plain text keys 6 are encrypted in the following manner by activating the encrypting function block 13 in the signal processing LSI 12 of the set 8. The plain text keys 6 written in the nonvolatile memory 9 as they are in a plain text format are read to the signal processing LSI 12, encrypted by the embedded encrypting function block 13, and then a resulting encryption key 20 is written back to the nonvolatile memory 9. When actually encrypting content data, the encryption key 20 is decrypted by the decrypting function block 14 in the signal processing LSI 12.

As described above, according to the comparative example of FIG. 4, since data of the device keys 5 is handled in a plain text key 6 format through a process of writing the encryption key 20 in the nonvolatile memory 9 and encrypting it, it is difficult to manage secret data. In addition, since the encrypting function block 13 in the signal processing LSI 12 is secret, whether or not data of the encryption key 20 is successfully written in the nonvolatile memory 9 cannot be verified.

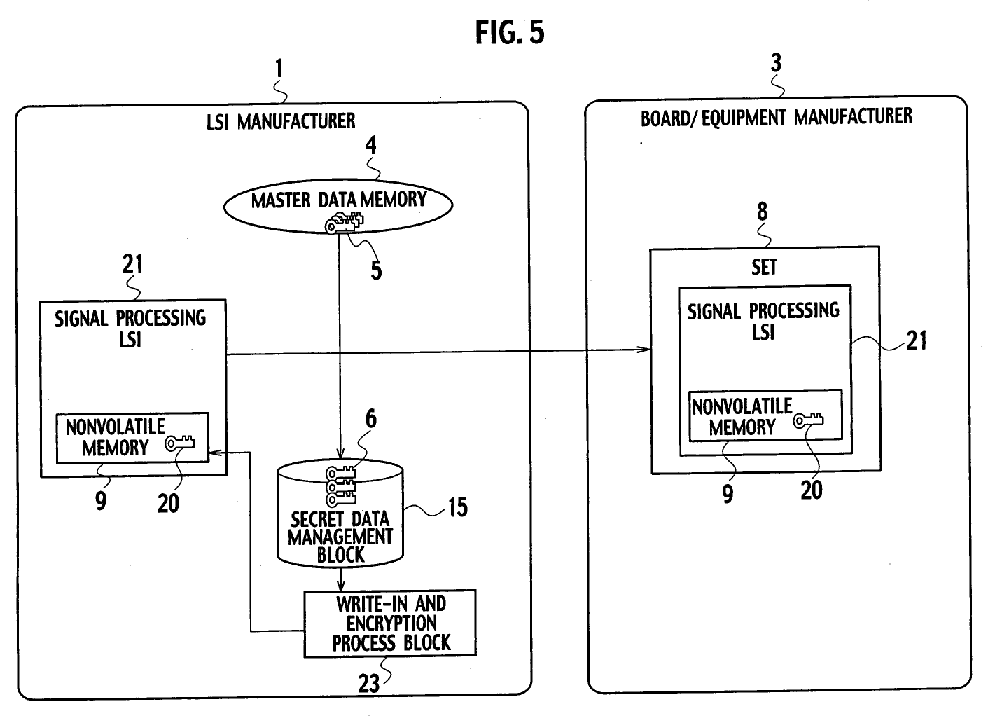

FIG. 5 shows yet another comparative example as a basis for the embodiments of the present invention. An LSI manufacturer 1 fabricates a signal processing LSI 21, which encrypts content data and functions as a nonvolatile memory 9. The signal processing LSI 21 is fabricated through a nonvolatile memory embedding process or fabricated as a multi-chip module constituted by the nonvolatile memory 9 and the signal processing LSI 21.

The LSI manufacturer 1 receives, from an encryption licensor, a master data memory 4 stored with, for example, one hundred thousand sets of device keys 5, and then converts the device keys 5 to plain text keys 6 via a secret data management block 15. The plain text keys 6 are written in the nonvolatile memory 9 as an encryption key 20 by a write-in/encryption process block 23. The nonvolatile memory 9 with the encryption key 20 stored therein is embedded in the signal processing LSI 21 for encrypting content data.

The LSI manufacturer 1 provides, to a board/equipment manufacturer 3, the signal processing LSI 21, which includes the nonvolatile memory 9 storing the encryption key 20. The board/equipment manufacturer 3 mounts the signal processing LSI 21 on a set 8 through an ordinary fabrication process.

As described above, according to the comparative example of FIG. 5, fabrication of the signal processing LSI 21, which encrypts content data and functions as a nonvolatile memory 9, increases LSI fabrication cost for the LSI manufacturer 1. Since a nonvolatile memory embedding process is more expensive than an ordinary process due to advances in miniaturization of the LSI fabrication process, it is difficult to fabricate such LSI including a nonvolatile memory. In addition, in the case of multi-chip module LSI, which includes a nonvolatile memory 9 chip and a signal processing LSI 21 chip for encrypting content data in the same package and fabricated without using the memory embedding process, the fabrication process is more complex, resulting in increased cost.

### FIRST EMBODIMENT

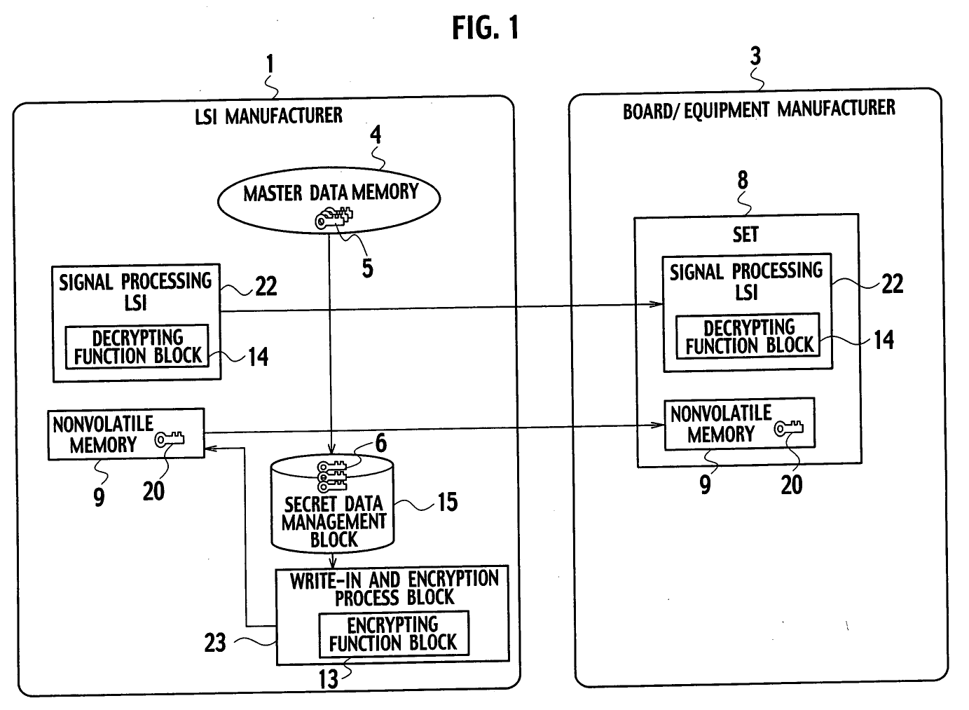

As shown in FIG. 1, a key management system according to the first embodiment of the present invention is constituted by a master data memory 4 storing with device keys 5, a secret data management block 15 which converts the device keys 5 to plain text keys 6, a write-in and encryption process block 23 which includes an encrypting function block 13 and encrypts the plain text keys 6, a nonvolatile memory 9 or a first chip which stores an encryption key 20 encrypted by the write-in and encryption process block 23, and a signal processing LSI 22 or a second chip which includes a decrypting function block 14 for decrypting the encryption key 20.

In addition, as shown in FIG. 1, a key management method according to the first embodiment of the present invention includes receiving the device keys 5 stored in the master data memory 4, converting the device keys 5 to the plain text keys 6 by the secret data management block 15, encrypting the plain text keys 6 by the write-in and encryption process block 23 which includes the encrypting function block 13, recording the encryption key 20 encrypted by the write-in and encryption process block 23 in the nonvolatile memory 9 or the first chip, and fabricating the signal processing LSI 22 or the second chip which includes the decrypting function block 14 for decrypting the encryption key 20.

FIG. 1 shows the key management system according to the first embodiment of the present invention. The system includes:

(a) An LSI manufacturer 1 receives, from an encryption licensor, the master data memory 4 stored with, for example, one hundred thousand sets of device keys 5, and then converts the device keys 5 to the plain text keys 6 (each being a device key in plain text for a single set) via the secret data management block 15. The plain text keys 6 are written in the nonvolatile memory 9 as the encryption key 20 by the write-in and encryption process block 23 including the encrypting function block 13. In addition, the LSI manufacturer 1 fabricates the signal processing LSI 22, which encrypts content data and includes the decrypting function block 14 for decrypting the encryption key 20, and provides the signal processing LSI 22 and the nonvolatile memory 9 stored with the encryption key 20, as a pair, to the board/equipment manufacturer 3.

(b) The board/equipment manufacturer 3 mounts the nonvolatile memory 9, stored with the encryption key 20, and the signal processing LSI 22 which includes the decrypting function block 14 in the set 8 through an ordinary fabrication process.

(c) When actually decrypting the encrypted contents, the encryption key 20 is decrypted by the decrypting function block 14 in the signal processing LSI 22.

The key management system according to the first embodiment of the present invention allows the board/equipment manufacturer 3 to mount the nonvolatile memory 9, such as an EEPROM, stored with encryption keys through an ordinary fabrication process, without knowledge of secret information management for device keys and the signal processing LSI 22, which provides a digital content copy protection system. The system permits omission of additional complex secret management processes.

In addition, according to the key management system of the first embodiment of the present invention, since the LSI manufacturer 1 carries out secret process management for encryption keys only to fabricate the nonvolatile memory 9, the board/equipment manufacturer 3 bears no burden. There is an advantage for the LSI manufacturer 1 that fabrication of the signal processing LSI 22, which provides a digital content copy protection system, allows use of an ordinary fabrication process without secret management for encryption keys.

Moreover, as miniaturization of the LSI fabrication process advances, it becomes difficult to integrate a nonvolatile memory, such as an EEPROM, into LSIs through an ordinary process, and expensive optional processes is essential. In contrast, the key management system and the method for the same according to the first embodiment of the present invention allow fabrication of the signal processing LSI 22, which provides a digital content copy protection system, through an ordinary process, thereby adapting to advanced processes. In addition, since the signal processing LSI 22 and the nonvolatile memory 9 constituting the set 8 can be fabricated in different chips, so that fabrication of an LSI including a memory through an optional process is unnecessary. Furthermore, since an ordinary package fabrication process is available, total chip cost is lower than the cost of fabricating a multi-chip package. Such multi-chip package encapsulates a single IC in which a signal processing LSI 22 chip fabricated through a miniaturization process and a nonvolatile memory 9 chip fabricated through a different process are integrated. The ordinary package fabrication process allows lower cost fabrication of the set 8.

The first embodiment of the present invention provides an inexpensive and secure key management system and method for the same, to provide a digital content copy protection system.

### SECOND EMBODIMENT

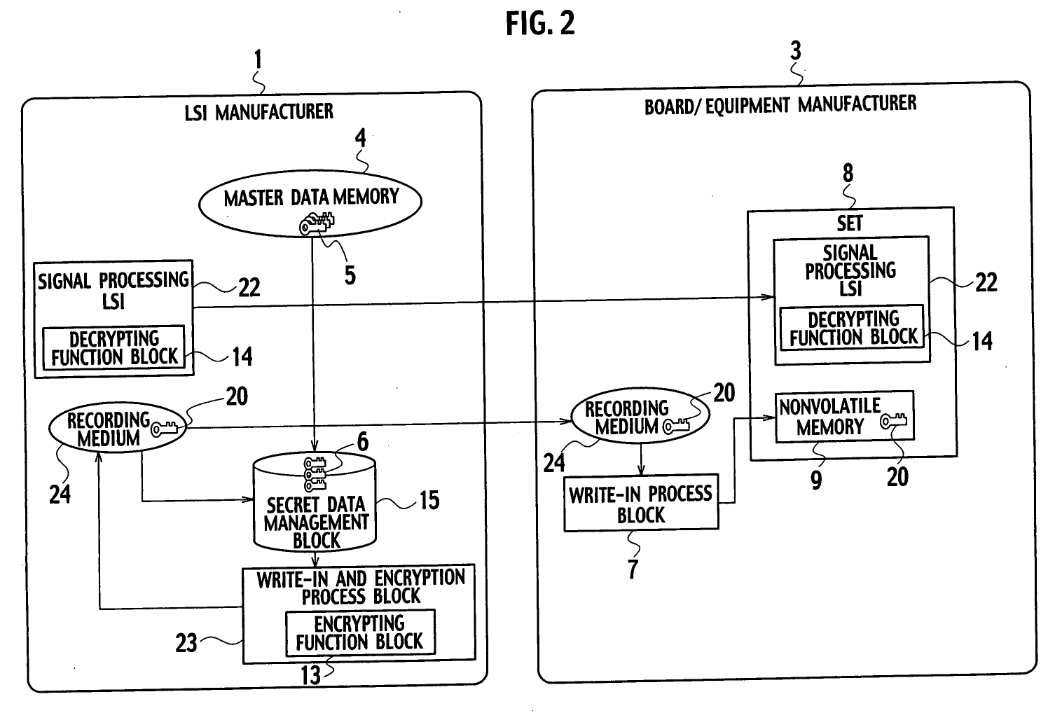

As shown in FIG. 2, a key management system according to the second embodiment of the present invention is constituted by a master data memory 4 storing with device keys 5, a secret data management block 15 which converts the device keys 5 to plain text keys 6, a write-in and encryption process block 23 which includes an encrypting function block 13 and encrypts the plain text keys 6, a recording medium 24 storing an encryption key 20 encrypted by the write-in and encryption process block 23, and a signal processing LSI 22 which includes a decrypting function block 14 for decrypting the encryption key 20.

Alternatively, as shown in FIG. 2, the key management system according to the second embodiment of the present invention further includes a write-in process block 7 which reads out the encryption key 20 from the recording medium 24 and then carries out write-in, and a nonvolatile memory 9 for storing the encryption key 20 resulting from having gone through a write-in process by the write-in process block 7. The recording medium 24 may be CD-ROM.

In addition, as shown in FIG. 2, a key management method according to the second embodiment of the present invention includes receiving the device key 5 stored in the master data memory 4, converting the device keys 5 to plain text keys 6 by the secret data management block 15, encrypting the plain text keys 6 by the write-in and encryption process block 23 which includes the encrypting function block 13, recording the encryption key 20 encrypted by the write-in and encryption process block 23 on the recording medium 24, fabricating the signal processing LSI 22 which includes the decrypting function block 14 for decrypting the encryption key 20, and reading out the encryption key 20 from the recording medium 24 and writing that encryption key 20 in the nonvolatile memory 9 by the write-in process block 7.

FIG. 2 shows the key management system according to the second embodiment of the present invention. The system includes:

(a) An LSI manufacturer 1 receives, from an encryption licensor, the master data memory 4 stored with, for example, one hundred thousand sets of device keys 5. The device keys 5 are then converted to the plain text keys 6 via the secret data management block 15. Each of the plain text keys 6 is subjected to processing by the write-in and encryption process block 23 including the encrypting function block 13. Thereby, providing the recording medium 24, such as a CD-ROM, stored with the encryption key 20

(b) The LSI manufacturer 1 fabricates the signal processing LSI 22, which encrypts content data and includes the decrypting function block 14 for decrypting the encryption key 20, and provides the signal processing LSI 22 and the recording medium 24, such as a CD-ROM stored with the encryption key 20, as a pair, to the board/equipment manufacturer 3.

(c) The board/equipment manufacturer 3 writes the encryption key 20 for each set stored in the recording medium 24 of master data 25 in the nonvolatile memory 9 of a set 8 by an ordinary write-in process block 7 which does not require secret data management.

(d) When actually decrypting the encrypted contents, the encryption key 20 is decrypted by the decrypting function block 14 in the signal processing LSI 22.

According to the key management system of the second embodiment of the present invention, the board/equipment manufacturer 3 can mount the nonvolatile memory 9, such as an EEPROM stored with encryption keys, and the signal processing LSI 22, which provides a digital content copy protection system, through an ordinary fabrication process without knowledge of secret information management for device keys. This allows omission of complex secret management processes.

In addition, according to the key management system of the second embodiment of the present invention and the method for the same, since the LSI manufacturer 1 carries out secret process management for encryption keys only to fabricate the recording medium 24 such as CD-ROM, the board/equipment manufacturer 3 bears no burden. There is an advantage for the LSI manufacturer 1 that fabrication of the signal processing LSI 22, which provides a digital content copy protection system, allows use of an ordinary fabrication process without secret management for encryption keys.

Moreover, as miniaturization of the LSI fabrication process continues, it becomes difficult to fabricate an LSI including a nonvolatile memory, such as an EEPROM, through an ordinary process, and expensive optional processes become essential. Alternatively, the key management system and the method for the same according to the second embodiment of the present invention allow fabrication of the signal processing LSI 22, which provides a digital content copy protection system, through an ordinary process. In addition, configuration of the signal processing LSI 22 and the nonvolatile memory 9 constituting the set 8 on different chips does not require consideration of fabricating an LSI including a memory through an optional process. Furthermore, since an ordinary package fabrication process is available, total chip cost is lower than the cost of fabricating a multi-chip package encapsulating a single LSI in which a signal processing LSI 22 chip, fabricated through a miniaturization process, and a nonvolatile memory 9 chip, fabricated through a different process, are integrated. This allows lower cost fabrication of the set 8.

Also, data in the recording medium 24 of FIG. 2 may be subjected to pretty good privacy (PGP) encryption by the LSI manufacturer 1, and may be used by decrypting the encryption (PGP) by the board/equipment manufacturer 3. This method increases the security level by receiving a CD-R stored with PGP encrypted data when purchasing a series of device keys 5 from a licensor. Alternatively, a transfer method based on a multi-encryption process, which repeats such encryption and decryption processes, may be used.

The second embodiment of the present invention provides an inexpensive and secure key management system and method for the same, so as to provide a digital content copy protection system.

### OTHER EMBODIMENTS

While the present invention is described in accordance with the aforementioned embodiments, it should not be understood that the description and drawings that configure part of this disclosure are to limit the present invention. This disclosure makes clear a variety of alternative embodiments, working examples, and operational techniques for those skilled in the art. Accordingly, the technical scope of the present invention is defined by only the claims that appear appropriate from the above explanation.

Various modifications will become possible for those skilled in the art after receiving the teachings of the present disclosure without departing from the scope thereof.

What is claimed is:

1. A key management system, comprising:
a master data memory configured to be stored with a device key;
a secret data management block configured to convert the device key to a plain text key;
a write-in and encryption process block configured to include an encryption function block and to encrypt the plain text key;
a nonvolatile memory configured in a first chip and stored with an encryption key encrypted by the write-in and encryption process block; and
a signal processing LSI configured in a second chip and including a decrypting function block for decrypting the encryption key.

2. The key management system of claim 1 further comprising:
a board on which the nonvolatile memory and the signal processing LSI are mounted.

3. The key management system of claim 1, wherein
the nonvolatile memory is an EEPROM.

4. The key management system of claim 1, wherein
the decrypting function block decrypts the encryption key by decrypting the encryption key.

5. The key management system of claim 1, wherein
the device key is pre-encrypted and the signal processing LSI decrypts the encrypted device key.

6. The key management system of claim 1, wherein
the device key is pre-PGP encrypted and the signal processing LSI decrypts the PGP-encrypted device key.

7. The key management system of claim 1, further comprising:
a multi-encryption/decryption process of repeating an encryption process and a decryption process for the device key by the signal processing LSI.

8. A key management system, comprising:
a master data memory configured to be stored with a device key;
a secret data management block configured to convert the device key to a plain text key;
a write-in and encryption process block configured to include an encryption function block and to encrypt the plain text key;
a recording medium configured to be stored with an encryption key encrypted by the write-in and encryption process block; and
a signal processing LSI including a decrypting function block for decrypting the encryption key.

9. The key management system of claim 8 further comprising:
a write-in process block configured to read out the encryption key stored in the recording medium and conduct a write-in process; and
a nonvolatile memory configured to be stored with the encryption key, which has been written in by the write-in process block.

10. The key management system of claim 9 further comprising:
a board on which the nonvolatile memory and the signal processing LSI are mounted.

11. The key management system of claim 9, wherein
the nonvolatile memory is an EEPROM.

12. The key management system of claim 9, wherein
the decrypting function block decrypts the encryption key by carrying out a decryption process for the encryption key.

13. The key management system of claim 9, wherein
the device key is pre-encrypted and the signal processing LSI decrypts the encrypted device key.

14. The key management system of claim 9, wherein
the device key is pre-PGP encrypted and the signal processing LSI decrypts the PGP-encrypted device key.

15. The key management system of claim 9, further comprising:
a multi-encryption/decryption process of repeating an encryption process and a decryption process for the device key by the signal processing LSI.

16. A key management method, comprising:
receiving a device key stored in a master data memory;
converting the device key to a plain text key by a secret data management block;
encrypting the plain text key by a write-in and encryption process block including an encryption function block;
recording an encryption key encrypted by the write-in and encryption process block in a nonvolatile memory configured in a first chip; and
fabricating a signal processing LSI configured in a second chip and including a decrypting function block for decrypting the encryption key.

17. The key management method of claim 16 further comprising:
mounting the nonvolatile memory and the signal processing LSI on a single board.

18. A key management method, comprising:
receiving a device key stored in a master data memory;
converting the device key to a plain text key by a secret data management block;
encrypting the plain text key by a write-in and encryption process block including an encryption function block;
storing, in a recording medium, an encryption key encrypted by the write-in and encryption process block; and
fabricating a signal processing LSI including a decrypting function block for decrypting the encryption key.

19. The key management method of claim 18 further comprising:
reading out the encryption key from the recording medium and conducting a write in process by the write-in process block; and
writing the encryption key in the nonvolatile memory, which has been written in by the write-in process block.

20. The key management method of claim 18, wherein
the decrypting function block decrypts the encryption key by carrying out a decryption process for the encryption key.
